(19) United States
(12) Patent Application Publication
(10) Pub. No.: US 2013/0002840 A1
(43) Pub. Date: Jan. 3, 2013

(54) METHOD AND APPARATUS FOR RECORDING MEDIA EVENTS

(75) Inventors: Aaron Toney, Issaquah, WA (US); Sean White, Los Angeles, CA (US)

(73) Assignee: Nokia Corporation

(21) Appl. No.: 13/173,965

(22) Filed: Jun. 30, 2011

(51) Int. Cl. H04N 7/18

(52) U.S. Cl. 348/61; 348/E07.085

(57) ABSTRACT

An apparatus, method, and computer program product are provided for recording media events. In particular, the apparatus includes a processor and a memory including computer program code that are configured to cause the apparatus to identify a party to the media event and access authorization data associated with the party. The authorization data may indicate whether the party consents to the recording of the party's participation in the media event and, if so, under what circumstances. Location data may also be accessed regarding the location of the party, and the location data may also be considered. In this way, the determination of whether the party's voice or image may be recorded can be based on the explicit consent of the party, the legal jurisdiction in which the media event takes place, the location or environment of the media event, or a combination of one or more of these factors.

### TECHNOLOGICAL FIELD

Embodiments of the present invention relate generally to the recording of media events that take place between two or more parties. In particular, embodiments of the present invention relate to an apparatus and method for recording media events by identifying a party to the media event and obtaining information regarding whether the party consents to having his or her voice and/or image recorded.

### BACKGROUND

With advancements in the field of telecommunications, the functionality of mobile devices such as cellular phones and portable digital assistants (PDAs) is continually enhanced. As a result, today's devices are capable of much more than just making phone calls or entering appointments on a calendar. Mobile terminals are now designed to have the combined functionality of cameras, video recorders, audio recorders, and other multimedia devices, making the recording of interactions between parties simpler and easier to execute.

The ease by which these interactions may be recorded is tempered by the restrictions that have been imposed by the law and by society in general. The individuals involved may need to consent to the recording, depending on the applicable laws in the jurisdiction in which that individual is found. Moreover, not all individuals may consent to having their voice or image recorded at all times in all places.

### BRIEF SUMMARY OF EXAMPLE EMBODIMENTS

Accordingly, embodiments of an apparatus, method, and computer program product are described that provide for an improved mechanism by which a user may identify a party to a media event and determine if and when the user may record the party's voice and/or image.

Embodiments of an apparatus for recording media events may include at least one processor and at least one memory including computer program code. The at least one memory and the computer program code may be configured to, with the processor, cause the apparatus to at least provide for identification of a party to a media event, access authorization data associated with the party, and provide for the recording of the party's participation in the media event based on the accessed authorization data. The authorization data may be indicative of the party's consent to the recording of the party's participation in the media event. The authorization data may, in some cases, be accessed from a repository.

In some embodiments, the memory and computer program code may be further configured to, with the processor, cause the apparatus to access identification data, and the identification of the party may be at least partly based on the accessed identification data. Furthermore, the memory and computer program code may be further configured to, with the processor, cause the apparatus to access social networking data, and the social networking data may comprise the identification data. Similarly, the memory and computer program code may be further configured to, with the processor, cause the apparatus to access social networking data, where the social networking data comprises the authorization data. In addition, at least a portion of the authorization data may be specific to a user recording the media event. In some cases, the memory and computer program code may be further configured to, with the processor, cause the apparatus to access location data associated with the party and to provide for the recording of the party's participation in the media event based on at least one of the accessed authorization data or the accessed location data.

Moreover, the memory and computer program code may be further configured to, with the processor, cause the apparatus to determine jurisdictional authorization for recording the party's participation in the media event without the party's consent based on the location data and to provide for the recording of the party's participation in the media event based on the jurisdictional authorization. In some cases, the location data may include geographic coordinates and/or information indicative of a type of establishment in which the party is located. In addition, the memory and computer program code may be further configured to, with the processor, cause the apparatus to preclude the recording of the media event based on the accessed authorization data, and/or may cause the apparatus to modify the recording of the media event based on the accessed authorization.

In other embodiments, a method and a computer program product are provided for recording media events. The method may include providing for identification of a party to a media event, accessing authorization data associated with the party via a processor, and providing for the recording of the party's participation in the media event based on the accessed authorization data. The authorization data may be indicative of the party's consent to the recording of the party's participation in the media event.

In some cases, the method may further include accessing social networking data, where the social networking data comprises the authorization data. In addition, location data associated with the party may be accessed. The recording of the party's participation in the media event may be provided for based on at least one of the accessed authorization data or the accessed location data.

The method may further include determining jurisdictional authorization based on the location data, where providing for the recording of the party's participation in the media event comprises providing for the recording of the party's participation in the media event based on the jurisdictional authorization. In some cases, the location data may include information indicative of a type of establishment in which the party is located.

In still other embodiments, an apparatus is provided for recording media events that includes means for providing for identification of a party to a media event, means for accessing authorization data associated with the party via a processor, and means for providing for the recording of the party's participation in the media event based on the accessed authorization data. The authorization data may be indicative of the party's consent to the recording of the party's participation in the media event.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a system for recording media events according to an example embodiment of the present invention;

FIG. 2 illustrates a schematic block diagram of a mobile terminal according to an example embodiment of the present invention;

FIG. 3 illustrates a schematic block diagram of an apparatus for recording media events according to an example embodiment of the present invention;

FIG. 4 illustrates a media event involving a user and a party in accordance with an example embodiment of the present invention;

FIG. 5 illustrates an authorization repository storing authorization data that is accessed by an apparatus in accordance with an example embodiment of the present invention;

FIG. 6 illustrates authorization data and location data associated with Party 5 of FIG. 5 that are accessed by an apparatus in accordance with an example embodiment of the present invention;

FIG. 7 illustrates authorization data and location data associated with Party 8 of FIG. 5 that are accessed by an apparatus in accordance with an example embodiment of the present invention;

FIG. 8 illustrates location data and jurisdictional data that are accessed by an apparatus in accordance with an example embodiment of the present invention; and

FIGS. 9-11 illustrate flowcharts of methods of recording media events according to an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

Advancements in technology have provided users with the ability to record images and sound using mobile terminals that are small, portable, and readily accessible in everyday situations. For example, most cellular telephones come equipped with video and audio recording functionality, such that users are able to record their interactions with other parties with the touch of a button.

Although users may have the ability to record conversations and events that take place in the vicinity of their user devices, such recordings may not necessarily be allowed or appropriate in every situation. A party to a media event, for example, may not wish to have his image or voice recorded, or may only allow certain people (e.g., family members or close friends) to record him. In some cases, the party may qualify his consent based on the situation or environment where he will be recorded. For example, the party may not wish to be recorded in a bar setting, or the party may only allow recordings when the party is at work.

Depending on the legal jurisdiction in which the media event is taking place, the party's consent to the recording may or may not be required. For example, in some jurisdictions, the law requires each party to a media event (e.g., the person doing the recording and the person being recorded) to consent to the recording. In other jurisdictions, the law only requires that one of the parties consent to the recording. Under such a law, for example, if the person who is making the recording consents to the recording (which is inferred from the fact that he is making the recording), then the consent of the party being recorded is unnecessary from a legal perspective.

In addition, and aside from the consent of the parties or the legality of the recording, it may be inappropriate to record parties in certain situations or locations. For example, it may be inappropriate to record a media event when the party is in the restroom.

Accordingly, embodiments of the apparatus, method, and computer program product described below provide for an improved mechanism by which a user may identify a party to a media event and determine if and when the user may record the party's voice or image. In some cases, described below, the determination of whether the party's voice or image may be recorded may be based on the explicit consent of the party, the legal jurisdiction in which the media event takes place, the location or environment of the media event, or a combination of one or more of these factors.

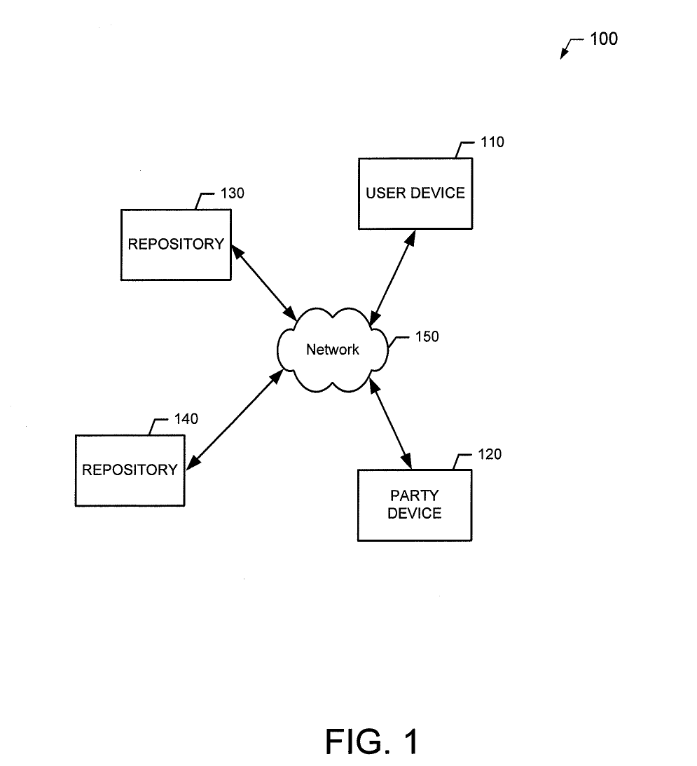

FIG. 1 illustrates a block diagram of a system 100 for identifying a party to a media event and determining whether a recording of the party's participation in the media event is authorized or appropriate. While FIG. 1 illustrates one example of a configuration of a system for recording a media event, numerous other configurations may be used to implement embodiments of the present invention.

As used herein, a “media event” is any situation involving a party (e.g., a person other than the user) that the user could record. Thus, the media event may be a conversation, a meeting, a special occasion (such as a birthday celebration), a dinner outing, or any other recordable scenario involving the party. The user (e.g., the person who is making the recording) may or may not be a participant in the media event. For example, in some cases, the user may take part in a conversation with the party or parties (e.g., the conversation may take place between the user and the party), whereas in other cases the user may simply be an observer and may record the party alone or with other parties (e.g., the conversation may take place between two parties). In some situations, the media event may include a number of “sub” media events. For example, a user may wish to record his or her experiences over an extended period of time, such as over the course of a day or a week. Thus, the recording of this period of time may include various conversations with different parties and other interactions, some of which may, for example, be discrete from other interactions and/or may themselves, under different circumstances, qualify as media events.

In any case, the recording may be of the image and/or the voice of the party or multiple parties. For example, the user may record a video (images and voice/sound or images alone), or the user may record audio (voice and/or sound without images). Although the examples used herein describe the recording of audio and/or video, embodiments of the invention apply to any recordable aspect of a media event. For example, in some embodiments, the recording of a media event may include the recording of a party's pulse rate, body temperature, blood pressure, or any other data regarding the party and/or the party's surroundings.

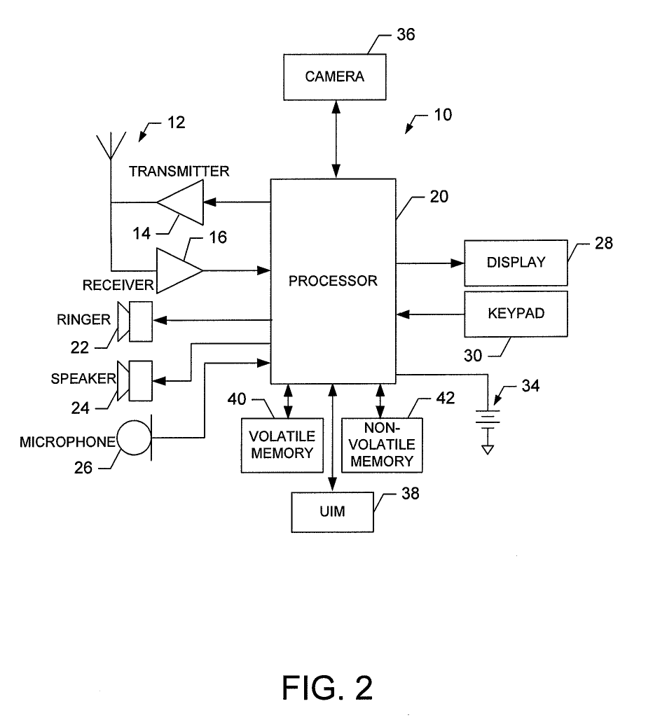

Referring to FIG. 1, the system 100 may include a user device 110, a party device 120, and one or more repositories 130, 140, that are configured to communicate over a network 150. The user device 110 may be any device that is configured to make video and/or audio recordings of media events in the vicinity of the device. For example, the user device 110 may be a mobile terminal 10 (shown in FIG. 2), and may consist of or include an apparatus 50 configured in accordance with embodiments of the present invention, as described below.

The party device 120 may be any device that the party can use to access and update authorization data regarding when and where the party may be recorded. Thus, the party device 120 may also be a mobile terminal 10 (shown in FIG. 2), such a computer or portable digital assistant (PDA). Each repository 130, 140 may be, for example, a dedicated server (e.g., a computer), a memory, a database, or other component that is configured to store authorization data pertaining to one or more parties. In this regard, a party may be able to access the authorization data residing in one or more repositories 130, 140 via the party device 120, such as by communicating with the repository via the network 150, as described in greater detail below.

As an example, the party device 120 may be a computer, and the repository 130, 140 may be a web host server, such as a social networking website server (e.g., Facebook, Twitter, or MySpace). In this example, the party may access his account on the social networking website via communication between his computer and the social networking website server over the network 150 (which, in this example, may be the Internet). As described in greater detail below, the party's account may include the party's preferences regarding when and where the party consents to being recorded. Thus, the party may be able to update his recording preferences when logged onto his social networking account. The user device 110 (such as the user's cellular phone, for example), may then be able to communicate with the repository 130, 140 (the social networking website server, in this example) to access the party's preferences to determine whether the user has the party's permission to record the party's participation in the media event.

Turning now to FIG. 2, a block diagram of a mobile terminal 10 that would benefit from embodiments of the present invention is illustrated. It should be understood, however, that the mobile terminal 10 as illustrated and hereinafter described is merely illustrative of one type of device that may benefit from embodiments of the present invention and, therefore, should not be taken to limit the scope of embodiments of the present invention. In particular, in some cases, the apparatus 50 may be embodied in a wearable device, such as a collar or a pair of glasses worn by the user. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

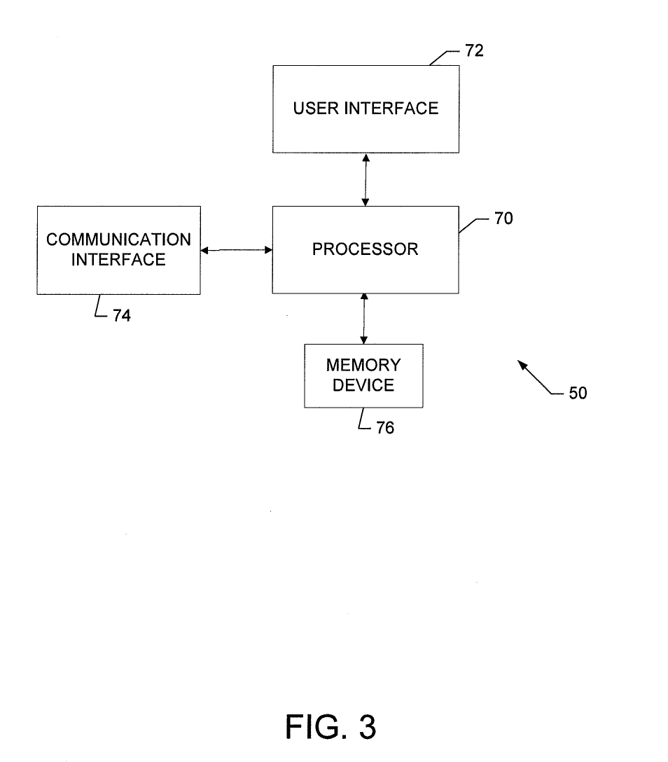

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 3), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may include a camera 36 or other media capturing element configured to capture images or video of objects, people, and places proximate to the user of the mobile terminal 10. The mobile terminal 10 (or even some other fixed terminal) may also practice example embodiments in connection with images or video content (among other types of content) that are produced or generated elsewhere, but are available for consumption at the mobile terminal 10 (or fixed terminal).

In an exemplary embodiment, the camera 36 is in communication with the processor 20. As noted above, the camera 36 may be any means for capturing an image for storage, display or transmission. For example, the camera 36 may include a digital camera capable of forming a digital image file from a captured image. As such, the camera 36 includes all hardware, such as a lens or other optical device, and software necessary for creating a digital image file from a captured image. Alternatively, the camera 36 may include only the hardware needed to view an image, while a memory device of the mobile terminal 10 stores instructions for execution by the processor 20 in the form of software necessary to create a digital image file from a captured image. In an exemplary embodiment, the camera 36 may further include a processing element such as a co-processor which assists the processor 20 in processing image data and an encoder and/or decoder for compressing and/or decompressing image data. The encoder and/or decoder may encode and/or decode according to a JPEG standard format. The camera 36 may also be configured to record sound corresponding to the images recorded, or, in some cases, the sound may be captured by the microphone 26 and correlated by the processor 20 with the images captured by the camera. The images and/or sounds that are recorded may be stored for future viewings and/or manipulations on a memory of the mobile terminal 10, such as the non-volatile memory 42, and/or on a memory external to the mobile terminal 10 itself.

An example embodiment of the invention will now be described with reference to FIG. 3, in which certain elements of an apparatus 50 for recording a media event are depicted. The apparatus 50 of FIG. 3 may be employed, for example, in conjunction with the user device 110 of FIG. 1, such as with the mobile terminal 10 of FIG. 2. However, it should be noted that the apparatus 50 of FIG. 3 may also be employed in connection with a variety of other devices, both mobile and fixed, and therefore, embodiments of the present invention should not be limited to application on devices such as the mobile terminal 10 of FIG. 2. For example, the apparatus 50 may be employed on a personal computer or other user terminal. Moreover, in some cases, the apparatus 50 may be on a fixed device such as a server or other service platform and the content may be presented (e.g., via a server/client relationship) on a remote device such as a user terminal (e.g., the mobile terminal 10) based on processing that occurs at the fixed device.

It should also be noted that while FIG. 3 illustrates one example of a configuration of an apparatus for identifying a party to a media event and determining whether a recording of the media event is authorized or appropriate, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 3, the apparatus 50 for recording a media event may include or otherwise be in communication with a processor 70, a user interface 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input and/or to cause provision of an audible, visual, mechanical or other output to the user. As such, the user interface 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

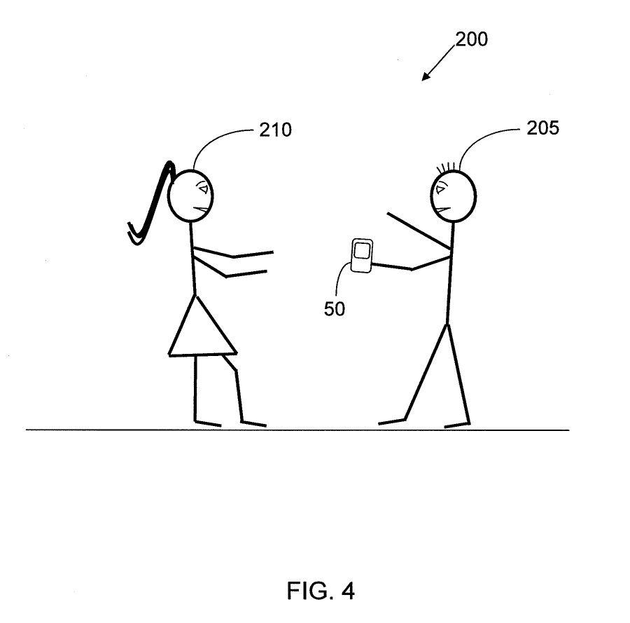

FIG. 4 depicts a media event 200 taking place between a user 205 and a party 210. For example, the user 205 and the party 210 may be discussing an idea that the party has for a new product line. As such, the user 205 may find it beneficial to record the party's thoughts and ideas in this case so that he is able to refer back to the details of their discussion later without having to take extensive notes.

The user 205 may be carrying with him an apparatus 50 that is capable of recording images and/or sound. The apparatus 50 may be embodied in a user device (e.g., the user device 110 of FIG. 1), such as the depicted cellular telephone, or may be a component of the user device, as described above.

Prior to recording his conversation with the party 210, the user 205 may wish to determine whether he has the party's consent for the recording. This may be because the user 205 does not want to break any laws (discussed below) or simply because the user does not wish to offend the party 210. Rather than disrupt the flow of conversation or otherwise bring attention to the fact that the party 210 will be recorded (which may make the party nervous or uncomfortable, regardless of consent), the user 205 may rely on the apparatus 50 to identify the party, determine whether the party has previously indicated consent to being recorded (by the user specifically or anyone in general), and provide for the recording to occur if such consent is in place.

Accordingly, the apparatus 50 may include at least one processor (such as the processor 70 of FIG. 3), and at least one memory (such as the memory device 76 of FIG. 3) including computer program code that is configured to, with the processor, cause the apparatus to provide for the identification of the party 210 to the media event 200. Such identification may occur in a number of ways. For example, the apparatus 50 or the user device in which the apparatus is embodied may include voice recognition capabilities, such that after the party 210 has spoken a few words, the apparatus 50 may be able to recognize the party's voice as belonging to a certain individual. Similarly, the apparatus 50 may include facial recognition or other identification functionality. Facial recognition, for example, may be implemented via a camera 36 (shown in FIG. 2) of the apparatus 50, wherein the camera may take a picture or video of the party's face prior to or at the onset of the conversation and the processor 20, 70 (depicted in FIG. 2 and FIG. 4, respectively) may analyze the picture and compare it against a database of faces or facial features to determine who the party 210 is.

In some cases, the party may be identified as belonging to a particular class or category of people. For example, rather than identify the individual (e.g., Mike Jones), the apparatus may be configured to identify that the party is a police officer, a first responder, a government official, or belongs to some other category. Such an identification may be based on the recognition of a type of uniform, for example, or other cues (e.g., audio or visual).

The memory and computer program code may, for example, be further configured to, with the processor, cause the apparatus to access identification data (e.g., data regarding the facial features of a number of parties). The identification of the party may thus be at least partly based on the accessed identification data. The identification data may, for example, be stored in an identification repository (e.g., a server) that could be external to the apparatus, such as in a separate device in communication with the apparatus or a cache of an external repository, or could be local to the apparatus. For example, in some cases, the apparatus may be caused to access social networking data (e.g., from a social networking website server), and the social networking data may include the identification data.

Alternatively or additionally, the user 205 may provide an input to the apparatus 50 indicating the party 210 or parties to the media event. This may be done, for example, through the entry of the party's telephone number, user name, account number, or other party identifier. In some cases, for example where the apparatus 50 is embodied on a cellular phone, the user 205 may identify the party 210 by selecting the party's name from a list of contacts.

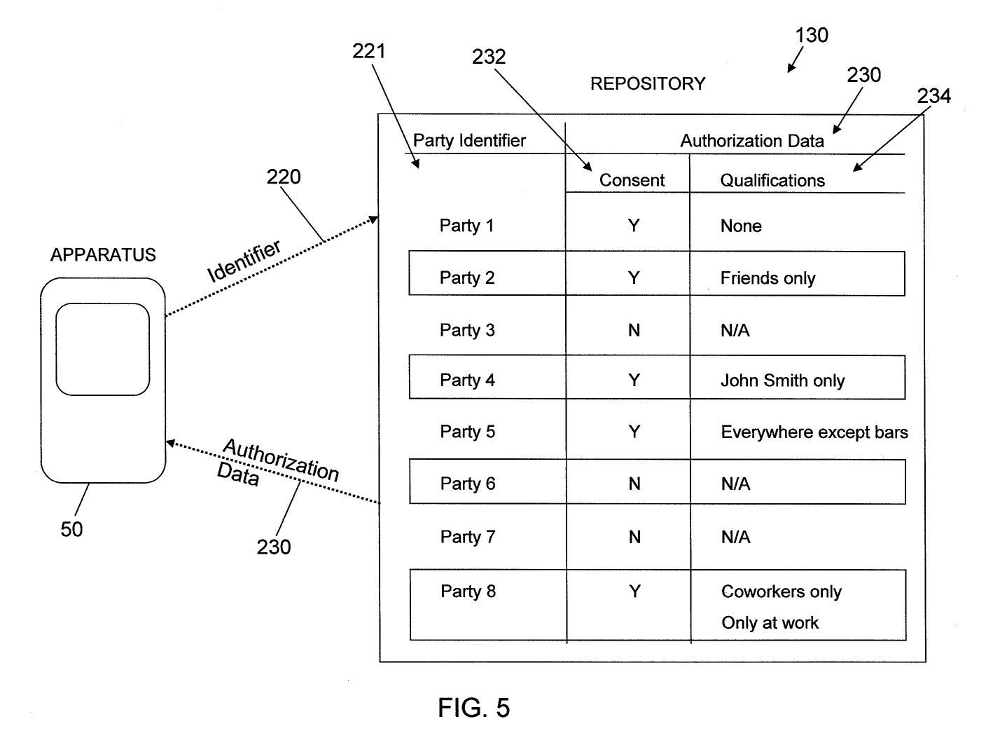

Once the party 210 is identified, the memory and computer program code may be configured to, with the processor, cause the apparatus 50 to access authorization data associated with the party. For example, with reference to FIG. 5, the authorization data may be accessed from an authorization repository 130 (e.g., through the party's prior interactions with the repository). The apparatus 50 may be configured to communicate with the authorization repository 130 (e.g., over a network 150, shown in FIG. 1, such as the Internet) and may use an identifier 220 corresponding to the identified party 210 to access the authorization data 230 associated with the party. In this regard, the authorization repository 130 may include a plurality of party identifiers 221 identifying a number of parties, as well as authorization data 230 associated with each identified party. The identifier 220 may, for example, be the party's name, phone number, account number, or any other indication capable of identifying the party. In some cases, the authorization repository 130, which may be an external repository or a local repository, may be the same or co-located with the identification repository.

The authorization data 230 may be indicative of the party's consent to the recording of the party's participation in the media event. For example, the authorization data 230 may include consent data 232 describing whether the party consents to being recorded and qualification data 234 describing any qualifications to the consent (e.g., describing certain circumstances under which the consent would be provided or withheld). For instance, in some embodiments, at least a portion of the authorization data may be specific to the user recording the media event.

In the case of Party 2, for example, although the consent data 232 indicates the party's consent to being recorded (“Y” indicating “Yes, I consent”), the qualification data 234 associated with Party 2 indicates that the consent applies to “Friends only.” The group of users under the category of “Friends” may be defined by Party 2 as part of the authorization data 230 or in data residing elsewhere in the repository 130 or in another repository in communication with the repository. For example, in cases where the repository 130 is a social networking website server and the data residing on the social networking website server is social networking data, the memory and computer program code may be further configured to, with the processor, cause the apparatus to access the social networking data, and the social networking data may in turn include the authorization data. In this case, the qualification of “Friends only” in the authorization data 230 associated with Party 2 may be defined by the list of “friends” indicated by Party 2 as part of his social networking profile. In other words, Party 2's consent to being recorded may only apply to those individuals that Party 2 has defined as “friends” for the purposes of viewing Party 2's social networking information.

Similarly, Party 8 in FIG. 5 has indicated that her consent (“Y” in the associated consent data 232) applies to her “Coworkers only.” Again, Party 8's coworkers may be defined by Party 8, for example as part of Party 8's social networking profile or other account information.

Instead of defining a group of users to whom the consent applies, the qualification data 234 may list certain individuals, only. Party 4's consent in FIG. 5, for example, applies only to one user—John Smith. Such user-specific authorization data may, for example, be tied to a specific user account (e.g., one of John Smith's social networking accounts in the previous example).

In cases in which consent is qualified based on the identity of the user, the apparatus 50 may be configured to determine whether the party's consent applies by correlating a user identifier with the particular user or group of users indicated in the qualifications 234 of the authorization data 230. The user identifier may, for example, be an identification of the particular apparatus 50 or user device 110 (FIG. 2) in which the apparatus 50 is embodied. In other words, the apparatus 50 may be associated with a particular user, such that identification of the apparatus may correspond to the identification of the user.

Embodiments of the apparatus 50 thus provide for the recording of the party's participation in the media event based on the accessed authorization data. In other words, the authorization data may describe the circumstances under which the identified party consents to being recorded. If the authorization data for the particular identified party indicates that the party consents to the recording of the particular media event, then the apparatus may be enabled to record the media event or, in cases where the apparatus is embodied as part of a user device with recording capabilities, the apparatus may communicate the authorization for the recording to another part of the user device (e.g., via the processor 70 of FIG. 2) to enable the recording functionality (e.g., via the camera 36 and/or microphone 26) of the user device (e.g., the mobile terminal 10). Alternatively, if the authorization data indicates that the identified party does not consent to the recording of the party's participation in the particular media event, then the recording functionality may be disabled, or the recording itself may be modified, as described below.

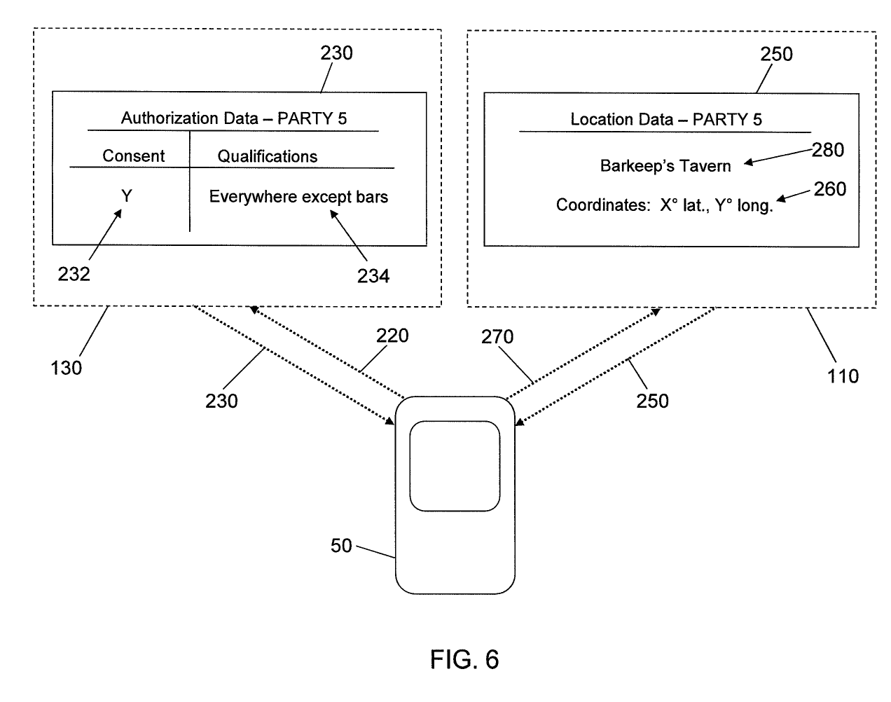

In some embodiments, the apparatus 50 may be caused to access location data associated with the party, and the apparatus may be caused to provide for the recording of the party's participation in the media event based on the accessed authorization data, the accessed location data, or a combination of the accessed authorization data and the accessed location data. For example, turning to FIG. 6, the authorization data 230 associated with Party 5 may indicate that Party 5 consents to being recorded “Everywhere except bars.” In other words, Party 5 in this example does not consent to being recorded when she is in a bar. This may be because Party 5 prefers not to be recorded when consuming alcohol or when she is with others who are consuming alcohol.

In this case, in addition to accessing authorization data 230 associated with Party 5, the apparatus 50 may also access location data 250 associated with the party. The location data 250 may include, for example, geographic coordinates 260 that describe the position of the apparatus 50 and/or user device 110 (FIG. 2). In other words, because the media event occurs proximate the apparatus 50, the party 210 is disposed proximate the apparatus 50, as shown in FIG. 4, and the geographic coordinates 260 describing the position of the apparatus 50 are, by extension associated with the party and the party's location. The geographic coordinates 260 may be obtained through the use of Global Positioning System (GPS) techniques. For example, the user device 110 in which the apparatus 50 is embodied may have GPS functionality (e.g., the user device may be a cellular phone with GPS capabilities), and the geographic coordinates 260 obtained through such GPS functionality describing the location of the user device may be stored in a memory of the user device 110, for example. Thus, in the depicted example, the apparatus 50 may access a memory of the user device 110 (e.g., through the use of an inquiry 270) to gain access to the geographic coordinates 260.

In some cases, the location data 250 includes information that is indicative of a type of establishment in which the party is located. The type of establishment in which the party is located could include, for example, a restaurant, a museum, a school, a bar, a doctor's office, a bank, a federal building, a state park, the party's home, the party's workplace, a place of worship, and so on. For example, the geographic coordinates 260 may correspond to the location of a restaurant and, as such, may be indicative of the type of establishment in which the party is located. The geographic coordinates 260 may, for example, be compared to a database of city landmarks and the coordinates of those landmarks to determine the type of establishment in which the apparatus 50 (and, by extension, the party) is located.

Alternatively, the type of establishment may be derived through other types of information. For example, the location of the party may be obtained from the party's published location, such as from the location identified by the party as the party's current location on a social networking website. As another example, the apparatus 50 (or the user device 110 in which the apparatus is embodied) may receive a wireless signal from a wireless network specific to a particular establishment or indicating the establishment originating the signal. A user device 110 located in an airport, for example, may receive wireless signals from the airport's wireless network, and the signals may identify the source of such signals as being the airport. Similarly, with reference to FIG. 6, the user device 110 attempting to record Party 5 may receive wireless signals (e.g., cellular or Internet signals) indicating that the user device is in “Barkeep's Tavern,” which is a bar. In this case, the apparatus 50 may provide for the recording of the party's participation in the media event based on a combination of the authorization data 230 (which indicates that Party 5's consent to being recorded applies everywhere except in bars) and information 280 in the location data 250 (which indicates that Party 5 is at Barkeep's Tavern, which is a bar). Thus, in this example, Party 5's participation in the media event at Barkeep's Tavern would not be recorded based on the accessed authorization data and the accessed location data.

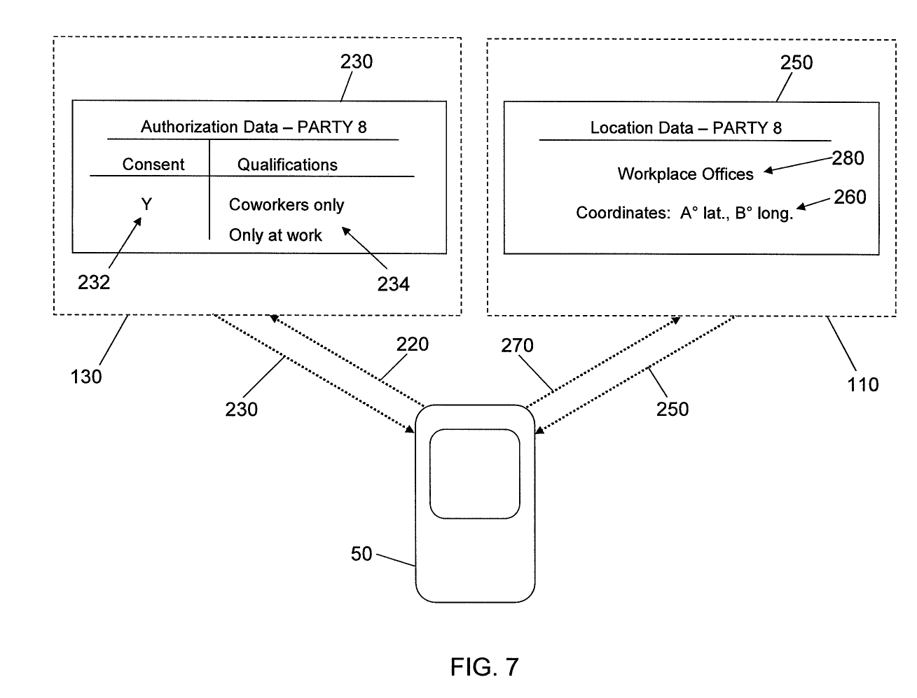

As another example, with reference to FIG. 7, the authorization data associated with Party 8 may indicate that Party 8's consent to being recorded extends only to users who are coworkers and only to media events that take place at work. In this case, the apparatus 50 may access the location data 250 (e.g., using an inquiry 270) and may obtain information indicating that Party 8 is at her workplace. Thus, in this example, the apparatus 50 may provide for the recording of the party's participation in the media event based on the accessed authorization data 230 (which indicates that Party 8 consents to being recorded only by her coworkers and only when she is at her place of work) and based on the accessed location data 250 (which indicates that Party 8 is at work).

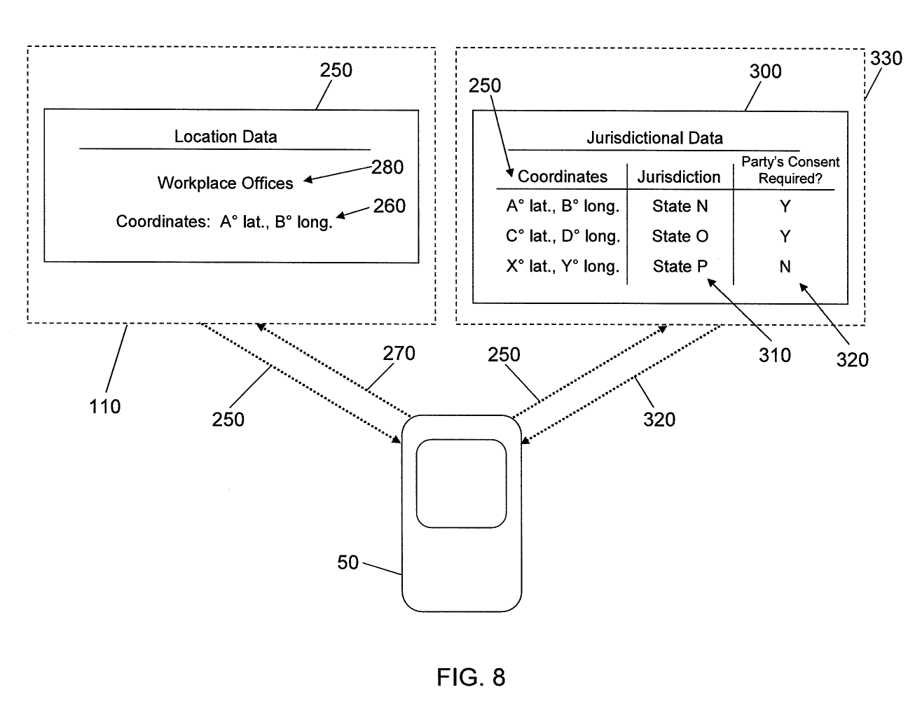

In some embodiments, the memory and computer program code may be configured to, with the processor, cause the apparatus to determine jurisdictional authorization for recording the party's participation in the media event without the party's consent based on the location data and to provide for the recording of the party's participation in the media event based on the jurisdictional authorization. For example, the apparatus 50 may be configured to access jurisdictional data 300 using the location data 250, as illustrated in FIG. 8. In particular, in some embodiments, geographic coordinates 260 (e.g., A° lat., B° long.) may be used to identify the legal jurisdiction 310 of the location of the apparatus 50 (e.g., State N), which may in turn be used to determine the jurisdictional authorization 320 for recording the party's participation in the media event without the party's explicit consent.

Referring to FIG. 8, geographic coordinates 260 of A° latitude, B° longitude may correspond to the jurisdiction of State N (i.e., A° latitude, B° longitude may describe a location in State N), and the applicable laws of State N may require that the consent of the party being recorded be obtained prior to recording his participation in the media event (e.g., indicated in the jurisdictional data 300 by a “Y”). In contrast, geographic coordinates 260 of X° latitude, Y° longitude may correspond to the jurisdiction of State P, and the applicable laws of State P may dictate that only one person involved in the media event is required to consent to the recording. In this case, because the user recording the media event implicitly consents to the recording, the consent of the party would not be required (e.g., indicated in the jurisdictional data 300 by an “N”).

Thus, for a media event taking place in State N according to this example, the apparatus 50 would need to access the authorization data associated with the party to ensure that the party consents to the recording. For a media event taking place in State P, however, accessing of the authorization data would not be required, as the party's consent is, in this case, unnecessary. In some embodiments, even in jurisdictions such as State P, where the party's consent is not required by law, the apparatus 50 may be configured to access the authorization data regardless of the jurisdictional authorization to record without consent, as the user may not wish to offend the party by recording his participation in the media event against the party's express desire not to be recorded.

The jurisdictional data 300 may be stored in any device, server, or other component in communication with the apparatus 50. For example, the jurisdictional data 300 may be stored on a state or federally maintained database 330, or, in some cases, may be stored in or in communication with the authorization repository 130, 140 (shown in FIG. 1).

As noted above, some embodiments of the invention that provide for the recording of the party's participation in the media event based on the accessed authorization data may also cause the apparatus to preclude the recording of the media event based on the accessed authorization data. For example, in some cases, if the authorization data indicates that the party does not consent to the recording of a particular media event (e.g., a media event to be recorded by a particular user and/or in a particular type of establishment), the recording functionality of the apparatus 50 and/or the user device 110 of FIGS. 1 and 2 may be temporarily inhibited, such that a recording of the media event is not possible. In other embodiments, however, the user may be able to override the determination that the media event is not to be recorded.

Furthermore, in some cases, the apparatus may be caused to modify the recording of the media event based on the accessed authorization data. For example, the non-consenting party's image and/or voice may be obscured, obfuscated, anonymized, or pseudonymized so as to keep the non-consenting party's identity hidden to those viewing the recording. For instance, the voice of the non-consenting party may, in some cases, be digitally altered or muffled to protect the non-consenting party's identity. Similarly, the image of the non-consenting party may be pixilated, covered, or otherwise hidden from view to protect the identity of the non-consenting party.

In some embodiments, the apparatus may be configured (e.g., by the user) to have default behavior in circumstances in which one or more of the parties involved in the media event do not consent to the recording. For example, the apparatus may be configured to preclude the recording of the media event (e.g., to refrain from recording any of the parties' participation) when one or more of the parties do not consent, or the apparatus may be configured to record the participation of all of the parties, regardless of the lack of consent of any of the parties, and/or to modify the recording to obscure the participation of the non-consenting parties.

In some cases, a party may not necessarily indicate consent or lack of consent regarding the recording of his participation in a media event. For example, an individual's social networking data may not include an indication of the party's consent because the party may not have specified this information in his social networking account profile. Thus, the apparatus may be configured to refrain from recording a party unless the party is associated with an explicit grant of consent to being recorded. Under this scenario, a party who has not provided consent information would, by default, not have his participation in a media event recorded. Alternatively, the apparatus may be configured to allow the recording of the party's participation in the media event unless the party is associated with an explicit lack of consent to being recorded. Thus, under this scenario, a party who has not provided consent information would, by default, have his participation in a media event recorded.

In still other cases, the apparatus may be configured such that the consent of parties who are incidentally recorded is ignored or otherwise not considered in the determination of whether to record the participation of the parties in the media event. In other words, the user may be recording a media event involving a number of individuals whose presence in the recording is either transient (e.g., such as a person walking by in the background of a recorded scene and whose presence in the recording is brief) or minor relative to the scope of the recording (e.g., a person far in the background of a recorded scene, such as a spectator in the crowd of a recorded sports event). Thus, the apparatus may be configured to provide for identification of a party and/or to consider the party's consent to the recording only after a certain recording threshold has been met. The recording threshold may be time-based (e.g., the party must be in the recorded scene for more than 5 or 10 seconds to have his consent considered), and/or the recording threshold may be content-based (e.g., the recorded data associated with the party, such as his voice or image, must make up at least 1% of the recorded content for the party's consent to be considered). In some cases, the party may not be identified at all unless the recording threshold is met for the particular party.

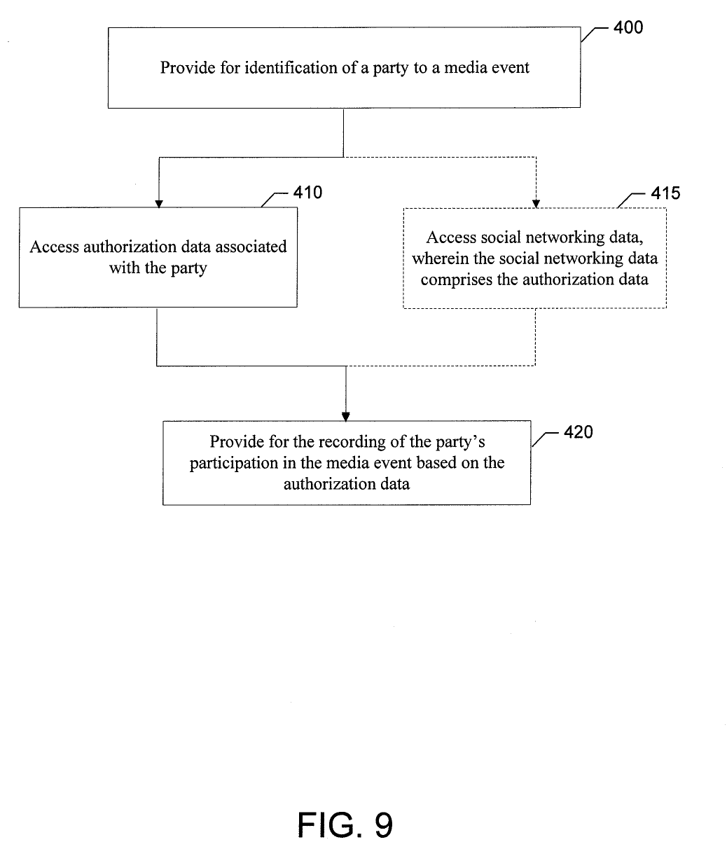

Turning now to FIGS. 9-11, flowcharts of a system, method, and computer program product are illustrated according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowcharts support combinations of means for performing the specified functions, combinations of operations for performing the specified functions, and program instruction means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In this regard, one embodiment of a method for recording media events is shown in FIG. 9. According to the depicted method, identification of a party to a media event is provided for at operation 400, and authorization data associated with the party is accessed at operation 410. As noted above, the authorization data may be indicative of the party's consent to the recording of the party's participation in the media event. The method further provides for the recording of the party's participation in the media event based on the authorization data at operation 420.

In some embodiments, social networking data may be accessed at operation 415, where the social networking data includes the authorization data. Furthermore, at least a portion of the authorization data may be specific to a user recording the media event. For example, as described above, the party's consent to the recording may be applicable only to certain users (such as only to coworkers or friends).

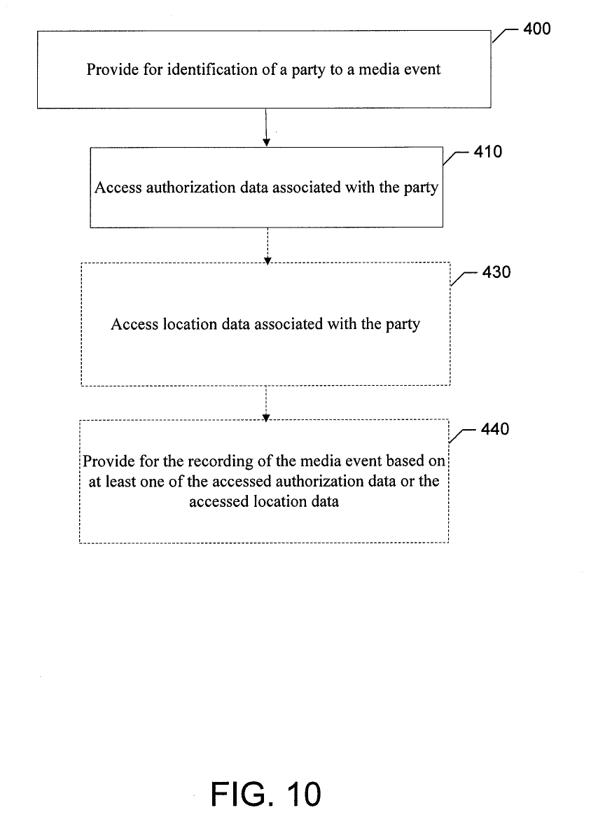

Turning to FIG. 10, in some embodiments, location data associated with the party may be accessed at operation 430. Thus, recording of the party's participation in the media event may be provided for in such cases at operation 440 based on at least one of the accessed authorization data or the accessed location data. For example, the location data may include information that is indicative of a type of establishment in which the party is located, and the authorization data may specify that the party's consent does not extend to the recording of media events taking place in that particular location, as described above.

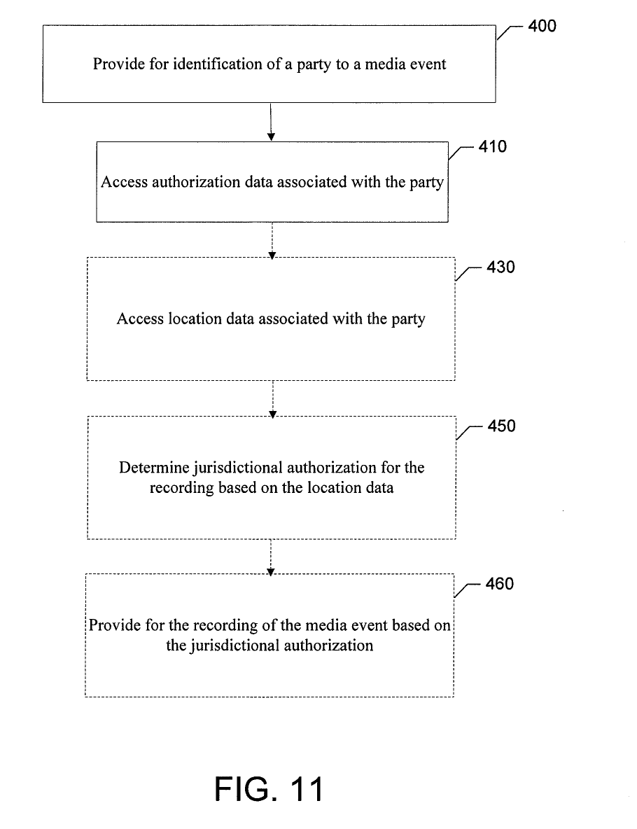

Moreover, as shown in FIG. 11, the method may include determining the jurisdictional authorization for the recording based on the location data at operation 450. For example, the location data may include geographic coordinates, and the geographic coordinates may be correlated to a particular state with laws regarding whether the party's consent is required for lawful recordings involving the party. In this case, the recording of the party's participation in the media event at operation 460 may be based on the jurisdictional authorization (which may, for example, indicate that the party's consent is unnecessary under the terms of the law).

Depending on whether the recording is authorized (based on the party's consent and/or under the particular legal jurisdiction, the recording may be enabled, precluded, or, in some cases, modified to exclude or obscure the image and/or voice of the non-consenting party.

In some embodiments, certain ones of the operations above may be modified or further amplified as described herein. Furthermore, in some embodiments, additional optional operations may be included, some examples of which are shown in dashed lines in FIGS. 9-11. Modifications, additions, or amplifications to the operations above may be performed in any order and in any combination.

In an example embodiment, an apparatus for performing the methods of FIGS. 9-11 above may comprise a processor (e.g., the processor 70 of FIG. 3) configured to perform some or each of the operations (400-460) described above. The processor may, for example, be configured to perform the operations (400-460) by performing hardware implemented logical functions, executing stored instructions, or executing algorithms for performing each of the operations. Alternatively, the apparatus may comprise means for performing each of the operations described above. In this regard, according to an example embodiment, examples of means for performing at least portions of operation 400 may comprise the processor 70, the memory device 76, the user interface 72, and/or a device or circuit for executing instructions or executing an algorithm for processing information as described above. Examples of means for performing at least portions of operations 410, 415, and 430 may comprise, for example, the processor 70, the communication interface 74, and/or a device or circuit for executing instructions or executing an algorithm for processing information as described above. Examples of means for performing at least portions of operation 450 may comprise, for example, the processor 70, the memory device 76, the communication interface 74, and/or a device or circuit for executing instructions or executing an algorithm for processing information as described above. Furthermore, examples of means for performing at least portions of operations 420, 440, and 460 may comprise, for example, the processor 70, the user interface 72, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

For example, although the examples above describe authorization data that may be indicative of a party's consent as applied to certain users and/or certain locations of the media event, other preferences of the party may be used to qualify the party's consent. The party's consent may, for example, be dependent on the timing of the media event (e.g., time of the day or day of the week). In addition, the authorization data may be configurable by the party, such as through the party's device 120 (FIG. 1), in real time or close to real time. Furthermore, parts of the authorization data may be directly configurable by the party, whereas other parts may be determined or derived from other data, apart from or used for different purposes than the authorization data. For example, at least some of the authorization data may be determined based on data indicated in the party's social networking account or profile.

Finally, although the examples described above relate to media events involving a single party, embodiments of the invention are also applicable to media events in which multiple parties are participants. In such cases, the apparatus may provide for the identification of each party to the media event and may access authorization data associated with each party, either in series or in parallel. The authorization data in such cases may be co-located (e.g., in a single authorization repository) or may be located across multiple repositories, such as across multiple servers. The authorization data for the different parties may be compared and/or cross-analyzed (e.g., by the processor) to determine whether the media event may be recorded and which, if any, of the parties may be included in the recording. For example, the apparatus may provide for the recordings differently based on whether all or only some of the involved parties consented to the recording of their participation. In jurisdictions requiring the consent of only one of the parties being recorded and one of the parties does consent, for example, the apparatus may be caused to provide for the recording of all of the participation of all the parties, despite the non-consent of some of the parties. In other jurisdictions requiring the consent of all involved, however, none of the parties' participation may be recorded, or the participation of the consenting parties may be recorded while the participation of any non-consenting parties is obscured or otherwise omitted from the recording.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
provide for identification of a party to a media event;
access authorization data associated with the party, wherein the authorization data is indicative of the party's consent to the recording of the party's participation in the media event; and
provide for the recording of the party's participation in the media event based on the accessed authorization data.

2. The apparatus of claim 1, wherein the authorization data is accessed from a repository.

3. The apparatus of claim 1, wherein the memory and computer program code are further configured to, with the processor, cause the apparatus to access identification data, wherein the identification of the party is at least partly based on the accessed identification data.

4. The apparatus of claim 3, wherein the memory and computer program code are further configured to, with the processor, cause the apparatus to access social networking data, wherein the social networking data comprises the identification data.

5. The apparatus of claim 1, wherein the memory and computer program code are further configured to, with the processor, cause the apparatus to access social networking data, wherein the social networking data comprises the authorization data.

6. The apparatus of claim 1, wherein at least a portion of the authorization data is specific to a user recording the media event.

7. The apparatus of claim 1, wherein the memory and computer program code are further configured to, with the processor, cause the apparatus to access location data associated with the party and to provide for the recording of the party's participation in the media event based on at least one of the accessed authorization data or the accessed location data.

8. The apparatus of claim 7, wherein the memory and computer program code are further configured to, with the processor, cause the apparatus to determine jurisdictional authorization for recording the party's participation in the media event without the party's consent based on the location data and to provide for the recording of the party's participation in the media event based on the jurisdictional authorization.

9. The apparatus of claim 7, wherein the location data comprises geographic coordinates.

10. The apparatus of claim 7, wherein the location data comprises information indicative of a type of establishment in which the party is located.

11. The apparatus of claim 1, wherein the memory and computer program code are further configured to, with the processor, cause the apparatus to preclude the recording of the media event based on the accessed authorization data.

12. The apparatus of claim 1, wherein the memory and computer program code are further configured to, with the processor, cause the apparatus to modify the recording of the media event based on the accessed authorization.

13. A method comprising:
providing for identification of a party to a media event;
accessing authorization data associated with the party via a processor, wherein the authorization data is indicative of the party's consent to the recording of the party's participation in the media event; and
providing for the recording of the party's participation in the media event based on the accessed authorization data.

14. The method of claim 13 further comprising accessing social networking data, wherein the social networking data comprises the authorization data.

15. The method of claim 13 further comprising accessing location data associated with the party, wherein providing for the recording of the party's participation in the media event comprises providing for the recording of the party's participation in the media event based on at least one of the accessed authorization data or the accessed location data.

16. The method of claim 15 further comprising determining jurisdictional authorization based on the location data, wherein providing for the recording of the party's participation in the media event comprises providing for the recording of the party's participation in the media event based on the jurisdictional authorization.

17. The method of claim 15, wherein the location data comprises information indicative of a type of establishment in which the party is located.

18. A computer program product comprising at least one computer-readable storage medium having computer-executable program code portions stored therein, the computer-executable program code portions comprising program code instructions for:
providing for identification of a party to a media event;
accessing authorization data associated with the party via a processor, wherein the authorization data is indicative of the party's consent to the recording of the party's participation in the media event; and
providing for the recording of the party's participation in the media event based on the accessed authorization data.

19. The computer program product of claim 18 further comprising program code instructions for accessing social networking data, wherein the social networking data comprises the authorization data.

20. The computer program product of claim 18 further comprising program code instructions for accessing location data associated with the party, wherein the program code instructions for providing for the recording of the party's participation in the media event further comprise program code instructions for providing for the recording of the party's participation in the media event based on at least one of the accessed authorization data or the accessed location data.
